(19) United States
(12) Patent Application Publication
(10) Pub. No.: US 2019/0381892 A1
(43) Pub. Date: Dec. 19, 2019

(54) VEHICLE POSITIONING SYSTEM

(71) Applicant: Delphi Technologies, LLC, Troy, MI (US)

(72) Inventor: Gary R. Thompson, Warren, OH (US)

(21) Appl. No.: 16/006,958

(22) Filed: Jun. 13, 2018

(51) Int. Cl. B60L 11/18; G05D 1/00; B62D 15/02; H04W 4/02

(52) U.S. Cl. CPC B60L 11/1833; G05D 1/0022; B62D 15/025; H04W 4/40; H04W 4/02; B60L 11/1838; B62D 15/029

(57) ABSTRACT

A positioning system includes a positioning-device, a second-transceiver, and one or more controller-circuits. The positioning-device determines a position of a vehicle moving proximate a power-transfer-zone. The positioning-device includes a first-transceiver transmitting signals indicative of the position relative to the power-transfer-zone. The second-transceiver is installed on the vehicle and receives the signals from the first-transceiver. The one or more controller-circuits are in communication with the positioning-device, the first-transceiver, the second-transceiver, and the vehicle. The positioning-device associates with the vehicle when the second-transceiver is within a sensing-range of the first-transceiver thereby directing the vehicle into the power-transfer-zone.

### TECHNICAL FIELD OF INVENTION

This disclosure generally relates to a positioning system, and more particularly relates to vehicle positioning system for directing an electric vehicle into a charging-zone.

### BRIEF DESCRIPTION OF DRAWINGS

The present invention will now be described, by way of example with reference to the accompanying drawings, in which:

FIG. 1 is an illustration of a positioning system in accordance with one embodiment;

FIG. 2 is another illustration of the positioning system of FIG. 1 in accordance with one embodiment; and

FIG. 3 is an illustration of a method of operating the positioning system of FIG. 1 accordance with another embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

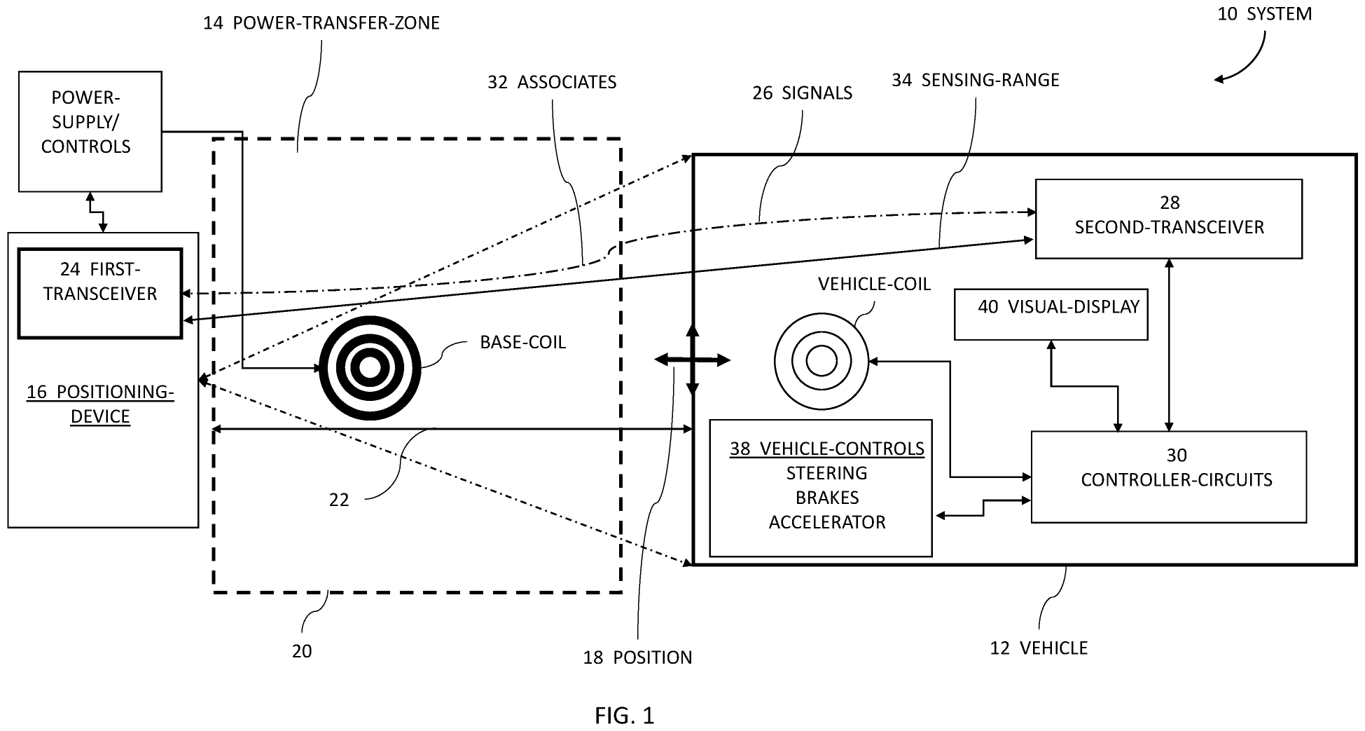

FIG. 1 is an illustration of a positioning system 10, hereafter referred to as the system 10. As will be described in more detail below, the system 10 is an improvement over other positioning systems, because the system 10 guides a vehicle 12 into a power-transfer-zone 14 of a charging-station before a vehicle-coil couples with a base-coil.

The system 10 includes a positioning-device 16 that determines a position 18 of the vehicle 12 moving proximate the power-transfer-zone 14. In the example illustrated in FIG. 1, the positioning-device 16 is remotely mounted (e.g., on a pedestal or a wall) and determines the position 18 of the vehicle 12 relative to boundaries 20 of the power-transfer-zone 14. The positioning-device 16 may be any positioning-device 16 suitable to detect the position 18 of the vehicle 12. One such positioning-device 16 is the LEDDAR® IS16, marketed by LeddarTech Inc. of Quebec City, Quebec, Canada.

The power-transfer-zone 14 includes the base-coil disposed within the power-transfer-zone 14 configured to emit a magnetic-field in response to electrical power applied to the base-coil. The base-coil (also referred to as a ground-coil or ground-assembly), may be any base-coil suitable for transferring energy to the vehicle 12 and preferably conforms to an SAE Recommended Practice J2954 NOV2017 specification. In general, a strength of the magnetic-field increases with increasing electrical power applied to the base-coil. Additionally, the strength of the magnetic-field is greatest proximate to the base-coil, and generally varies inversely with the third-power of distance away from the base-coil. An exposed base-coil (i.e. the base-coil not covered or not overlaid by the vehicle 12) is typically limited to a magnetic-field with a maximum strength of 15 microteslas (15 μT), based on an International Commission on Non-Ionizing Radiation Protection 2010 (ICNIRP 2010) safety limit for implanted electronic pacemakers. Prior art power transfer systems typically require the vehicle-coil to be aligned (i.e. positioned above, etc.) with the base-coil for optimum power transfer before increasing the strength of the magnetic-field of the base-coil. This requirement to limit the strength of the magnetic-field results in the vehicle-coil initially coupling with base-coil for short-range alignment at a distance less than approximately 300 mm, due to the relatively low strength of magnetic-field of 15 μT. This relatively short range (i.e., 300 mm) leaves little distance for maneuvering the vehicle 12 into and/or within the power-transfer-zone 14. By increasing a guidance-distance 22 for the vehicle 12 beyond the boundary 20 of the power-transfer-zone 14, the system 10 enables the vehicle 12 to maneuver for optimum alignment between the base-coil and the vehicle-coil.

The positioning-device 16 includes a first-transceiver 24 transmitting signals 26 indicative of the position 18 of the vehicle 12 relative to the power-transfer-zone 14. That is, the first-transceiver 24, which is capable of both transmitting and receiving, transmits signals 26 wirelessly (e.g., using IEEE 802.11, cellular, dedicated short range communication (DSRC), BLUETOOTH®, and/or infrared, etc. protocols) to the vehicle 12 based on the information received from the positioning-device 16. In the example illustrated in FIG. 1, the first-transceiver 24 transmits signals 26 that are characterized as being within an infrared spectrum of light.

The system 10 also includes a second-transceiver 28 installed on the vehicle 12 that receives the signals 26 from the first-transceiver 24. The second-transceiver 28 is also capable of both transmitting and receiving signals 26 wirelessly.

The system 10 also includes one or more controller-circuits 30 in communication with the positioning-device 16, the first-transceiver 24, the second-transceiver 28, and the vehicle 12. As illustrated in FIG. 1, the one or more controller-circuits 30 are installed on the vehicle 12. In another embodiment not shown, the one or more controller-circuits 30 are distributed among the vehicle 12, and the positioning-device 16. The one or more controller-circuits 30 may include a processor (not shown) such as a microprocessor or other control circuitry such as analog and/or digital control circuitry including an application specific integrated circuit (ASIC) for processing data as should be evident to those in the art. The one or more controller-circuits 30 may include a memory (not shown), including non-volatile memory, such as electrically erasable programmable read-only memory (EEPROM) for storing one or more routines, threshold values, and captured data. The one or more routines may be executed by the processor to perform steps for determining the position 18 of the vehicle 12 based on the signals 26 received by the one or more controller-circuits 30 from the positioning-device 16, as described herein. The one or more controller-circuits 30 are configured to operate the vehicle 12 in an automated-mode characterized by the one or more controller-circuits 30 steering the vehicle 12. As used herein, the term automated-mode is not meant to suggest that fully automated or autonomous operation of the vehicle 12 is required. It is contemplated that the teachings presented herein are applicable to instances where the vehicle 12 is entirely manually operated by a human and the automation is merely providing emergency vehicle 12 controls to the human.

The positioning-device 16 associates 32 with the vehicle 12 when the second-transceiver 28 is within a sensing-range 34 of the first-transceiver 24. As used herein, the term “associates” includes the positioning-device 16 establishing an exclusive bi-directional communication with the vehicle 12 via the first-transceiver 24 and the second-transceiver 28 when the second-transceiver 28 is within the sensing-range 34 of the first-transceiver 24. An IP address of the charging-station, and/or other information related to the charging-station, may be communicated to the vehicle 12 once the positioning-device 16 associates 32 with the vehicle 12. The sensing-range 34 varies with the type of signal 26 transmitted, and for the infrared signal 26 is up to about 20 meters (m) along a line-of-sight, and may be greater than 20 m for other wireless signals 26 (e.g. IEEE 802.11, cellular, DSRC, BLUETOOTH®, etc.).

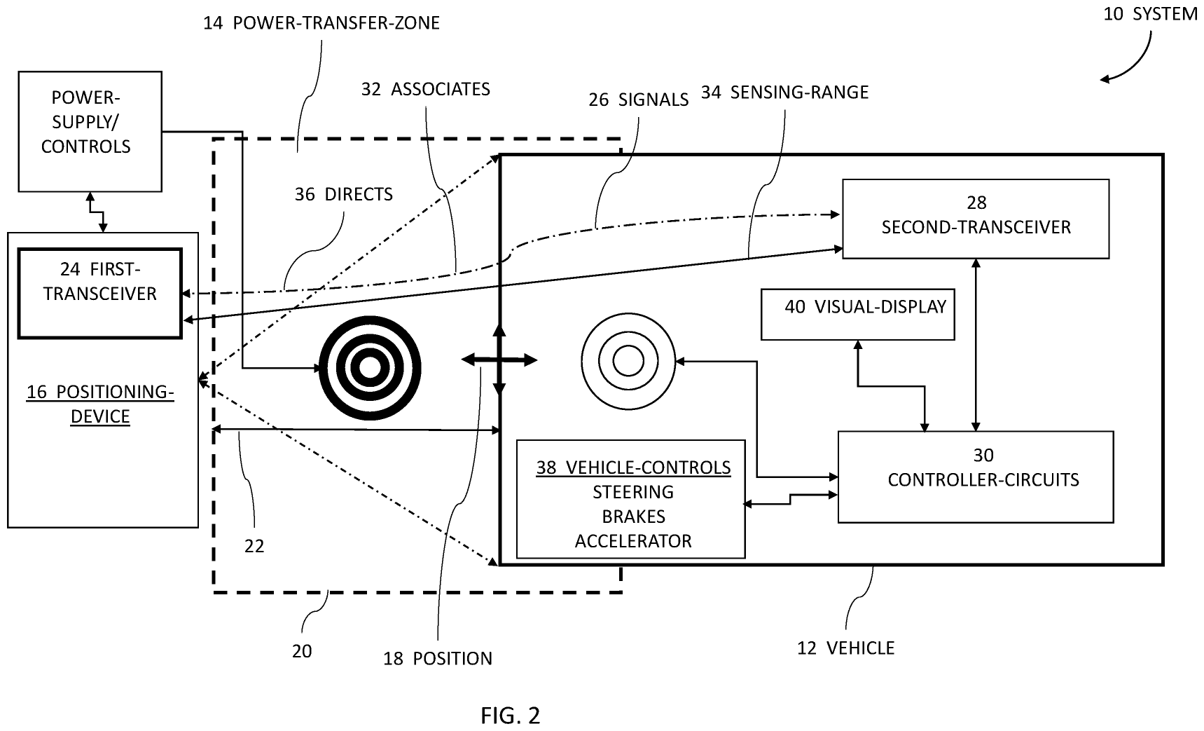

FIG. 2 illustrates the vehicle 12 entering the power-transfer-zone 14 after the positioning-device 16 associates 32 with the vehicle 12. The positioning-device 16 directs 36 the vehicle 12 into the power-transfer-zone 14 (i.e. provides maneuvering directions to the vehicle 12) to optimally position the base-coil and the vehicle-coil for coupling, as described above. In one embodiment, the system 10 further includes vehicle-controls 38 in communication with the one or more controller-circuits 30, and the one or more controller-circuits 30 steer the vehicle 12 into the power-transfer-zone 14. In another embodiment, the system 10 further includes a visual-display 40 installed in the vehicle 12 in communication with the one or more controller-circuits 30, and the one or more controller-circuits 30 displays the directions to an operator (not shown) of the vehicle 12 on the visual-display 40.

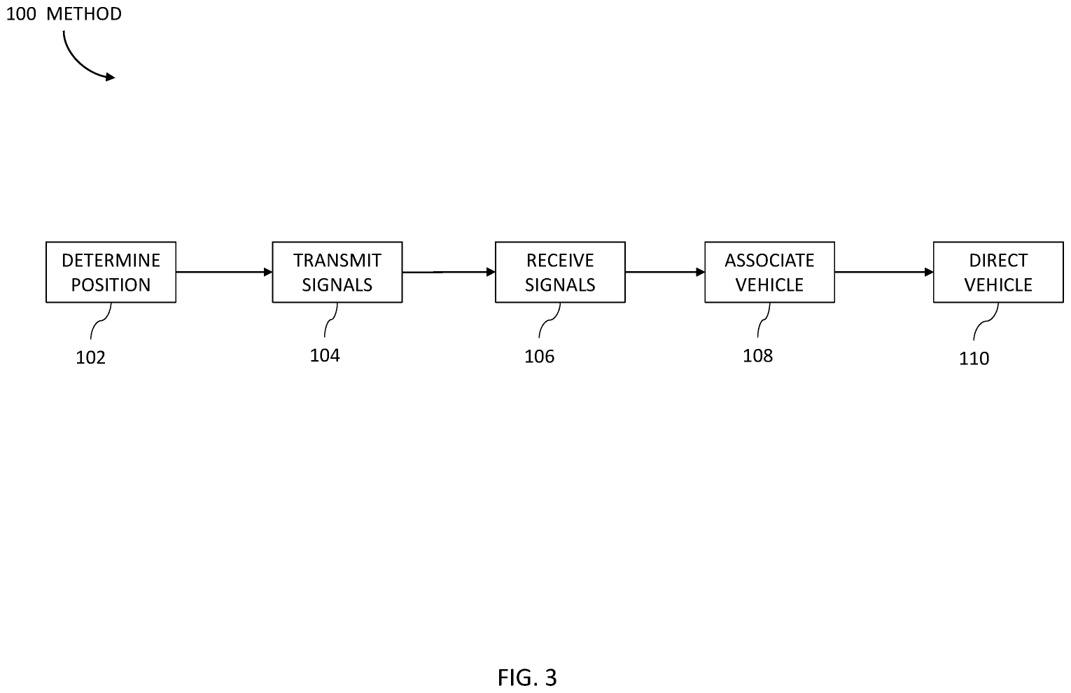

FIG. 3 is a flow chart illustrating another embodiment of a method 100 of operating a positioning system 10, hereafter referred to as the system 10.

Step 102, DETERMINE POSITION, includes determining a position 18 of a vehicle 12 moving proximate a power-transfer-zone 14 with a positioning-device 16, as described above. The positioning-device 16 includes a first-transceiver 24 capable of both transmitting and receiving signals 26 wirelessly as described above.

Step 104, TRANSMIT SIGNALS, includes wirelessly transmitting signals 26 indicative of the position 18 of the vehicle 12 relative to the power-transfer-zone 14 with the first-transceiver 24. In the example illustrated in FIG. 1, the first-transceiver 24 transmits signals 26 that are characterized as being within an infrared spectrum of light.

Step 106, RECEIVE SIGNALS, includes receiving the signals 26 from the first-transceiver 24 with a second-transceiver 28 installed on the vehicle 12, as described above.

Step 108, ASSOCIATE VEHICLE, includes associating 32 the positioning-device 16 with the vehicle 12, with one or more controller-circuits 30 in communication with the positioning-device 16, the first-transceiver 24, the second-transceiver 28, and the vehicle 12, when the second-transceiver 28 is within a sensing-range 34 of the first-transceiver 24 as described above. Associating 32 includes the positioning-device 16 establishing an exclusive bi-directional communication with the vehicle 12 via the first-transceiver 24 and the second-transceiver 28 when the second-transceiver 28 is within the sensing-range 34 of the first-transceiver 24.

Step 110, DIRECT VEHICLE, includes directing 36 the vehicle 12 into the power-transfer-zone 14. In one embodiment, the system 10 further includes vehicle-controls 38 in communication with the one or more controller-circuits 30, and the one or more controller-circuits 30 steer the vehicle 12 into the power-transfer-zone 14. In another embodiment, the system 10 further includes a visual-display 40 installed in the vehicle 12 in communication with the one or more controller-circuits 30, and the one or more controller-circuits 30 displays the directions 36 to an operator (not shown) of the vehicle 12 on the visual-display 40.

Accordingly, a positioning system 10 (the system 10), and a method 100 of operating the system 10 are provided. The system 10 is an improvement over prior art positioning systems because the system 10 increases the guidance-distance 22 for the vehicle 12 beyond the boundary 20 of the power-transfer-zone 14.

While this invention has been described in terms of the preferred embodiments thereof, it is not intended to be so limited, but rather only to the extent set forth in the claims that follow. “One or more” includes a function being performed by one element, a function being performed by more than one element, e.g., in a distributed fashion, several functions being performed by one element, several functions being performed by several elements, or any combination of the above. It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact. The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],”depending on the context. Directional terms such as top, bottom, upper, lower, left, right, front, rear, etc. do not denote any particular orientation, but rather these directional terms are used to distinguish one element from another and establish a relationship between the various elements.

We claim:

1. A positioning system, said system comprising:
a positioning-device, the positioning-device determining a position of a vehicle moving proximate a power-transfer-zone;
the positioning-device including a first-transceiver transmitting signals indicative of the position relative to the power-transfer-zone;
a second-transceiver installed on the vehicle, the second-transceiver receiving the signals from the first-transceiver; and
one or more controller-circuits in communication with the positioning-device, the first-transceiver, the second-transceiver, and the vehicle
wherein the positioning-device associates with the vehicle when the second-transceiver is within a sensing-range of the first-transceiver thereby directing the vehicle into the power-transfer-zone.

2. The system in accordance with claim 1, wherein the one or more controller-circuits steers the vehicle into the power-transfer-zone.

3. The system in accordance with claim 1, wherein the system further includes a visual-display installed in the vehicle in communication with the one or more controller-circuits, and the one or more controller-circuits displays the directions to an operator of the vehicle on the visual-display.

4. The system in accordance with claim 1, wherein the signals are transmitted wirelessly by the first-transceiver.

5. The system in accordance with claim 4, wherein the signals are characterized as being within an infrared spectrum of light.

6. The system in accordance with claim 1, wherein the positioning-device establishes an exclusive bi-directional communication with the vehicle via the first-transceiver and the second-transceiver when the second-transceiver is within the sensing-range of the first-transceiver.

7. A method of operating a positioning system, said method comprising:
determining a position of a vehicle moving proximate a power-transfer-zone with a positioning-device, the positioning-device including a first-transceiver;
transmitting signals indicative of the position relative to the power-transfer-zone with the first-transceiver;
receiving the signals from the first-transceiver with a second-transceiver installed on the vehicle; and
associating the positioning-device with the vehicle, with one or more controller-circuits in communication with the positioning-device, the first-transceiver, the second-transceiver, and the vehicle when the second-transceiver is within a sensing-range of the first-transceiver; and
directing the vehicle into the power-transfer-zone.

8. The method in accordance with claim 7, further including the step of steering the vehicle into the power-transfer-zone with the one or more controller-circuits.

9. The method in accordance with claim 7, wherein the system further includes a visual-display installed in the vehicle in communication with the one or more controller-circuits, further including the step of displaying the directions to an operator of the vehicle with the one or more controller-circuits on the visual-display.

10. The method in accordance with claim 7, further including the step of wirelessly transmitting the signals by the first-transceiver.

11. The method in accordance with claim 10, wherein the signals are characterized as being within an infrared spectrum of light.

12. The method in accordance with claim 7, further including the step of establishing an exclusive bi-directional communication between the positioning-device and the vehicle via the first-transceiver and the second-transceiver, when the second-transceiver is within the sensing-range of the first-transceiver.

13. A means for directing a vehicle, comprising:
a positioning-means determining a position of the vehicle moving proximate a power-transfer-zone;
the positioning-means including a first-means of transceiving signals, the signals indicative of the position relative to the power-transfer-zone;
a second-means of transceiving signals installed on the vehicle, the second-means of transceiving signals receiving the signals from the first-means of transceiving signals; and
one or more controller-means in communication with the positioning-means, the first-means of transceiving signals, second-means of transceiving signals, and the vehicle:
wherein the positioning-means associates with the vehicle when the second-means of transceiving signals is within a sensing-range of the first-means of transceiving signals thereby directing the vehicle into the power-transfer-zone.

14. The means for directing a vehicle in accordance with claim 13, wherein the one or more controller-means steers the vehicle into the power-transfer-zone.

15. The means for directing a vehicle in accordance with claim 13, wherein the means for directing the vehicle further includes a visual-display-means installed in the vehicle in communication with the one or more controller-means, and the one or more controller-means displays the directions to an operator of the vehicle on the visual-display-means.

16. The means for directing a vehicle in accordance with claim 13, wherein the signals are transmitted wirelessly by the first-means of transceiving signals.

17. The means for directing a vehicle in accordance with claim 16, wherein the signals are characterized as being within an infrared spectrum of light.

18. The means for directing a vehicle in accordance with claim 13, wherein the positioning-means establishes an exclusive bi-directional communication with the vehicle via the first-means of transceiving signals and the second-means of transceiving signals when the second-means of transceiving signals is within the sensing-range of the first-means of transceiving signals.
